(19) United States
(12) Patent Application Publication
(10) Pub. No.: US 2020/0393590 A1
(43) Pub. Date: Dec. 17, 2020

(54) LOW FREQUENCY ACQUISITION WITH TOWED STREAMERS

(71) Applicant: PGS Geophysical AS, Oslo (NO)

(72) Inventor: Stig Rune Lennart TENGHAMN, Houston, TX (US)

(21) Appl. No.: 16/881,944

(22) Filed: May 22, 2020

Related U.S. Application Data
(60) Provisional application No. 62/860,334, filed on Jun. 12, 2019.

(51) Int. Cl. G01V 1/38

(52) U.S. Cl. CPC G01V 1/3808; G01V 1/3843

(57) ABSTRACT

A method and apparatus for generating a geophysical data product by a process of: acquiring standard-offset survey data for a subterranean formation with a standard-offset survey spread towed at a standard-offset spread depth; acquiring long-offset survey data for the subterranean formation with a long-offset streamer towed at a long-offset streamer depth; and assembling the long-offset survey data into a set of grouped-long-offset survey data characterized by a plurality of receiver groupings and a group length. A method, includes: towing a standard-offset survey spread at a standard-offset spread depth; acquiring standard-offset survey data for a subterranean formation with the standard-offset survey spread; towing a long-offset streamer with a vessel at a long-offset streamer depth; acquiring long-offset survey data for the subterranean formation with the long-offset streamer; and assembling the long-offset survey data into a set of grouped-long-offset survey data characterized by a plurality of receiver groupings and a group length.

### CROSS REFERENCE TO RELATED APPLICATIONS

This application claims benefit of U.S. Provisional Patent Application Ser. No. 62/860,334, filed Jun. 12, 2019, entitled “Low Frequency Acquisition with Towed Streamers,” which is incorporated herein by reference.

### BACKGROUND

This disclosure is related generally to the field of marine surveying. Marine surveying can include, for example, seismic and/or electromagnetic surveying, among others. For example, this disclosure may have applications in marine surveying in which one or more sources are used to generate energy (e.g., wavefields, pulses, signals), and geophysical sensors—either towed or ocean bottom—receive energy generated by the sources and possibly affected by interaction with subsurface formations. Geophysical sensors may be towed on cables referred to as streamers. Some marine surveys locate geophysical sensors on ocean bottom cables or nodes in addition to, or instead of, streamers. The geophysical sensors thereby collect survey data (e.g., seismic data, electromagnetic data) which can be useful in the discovery and/or extraction of hydrocarbons from subsurface formations.

Some marine surveys deploy sources and receivers at long offsets to better acquire certain types of survey data. For example, long offsets may be beneficial for sub-salt and pre-salt imaging. Such long-offset surveys typically utilize ocean bottom cables or nodes. As another example, some very-low-frequency (e.g., as low as 1.6 Hz) sources may utilize receivers at long offsets (e.g., over 30 km) to acquire survey data optimized for full-waveform inversion (FWI). As another example, continuous long-offset (CLO) acquisition combines a dual source-vessel operation using only short streamers with a smart recording technique involving overlapping records. While dual source-vessel operations can increase the offset to effectively twice the streamer length, the inline shot spacing is also doubled in comparison to conventional single source-vessel operations. Simultaneous long-offset (SLO) acquisition modifies CLO acquisition by utilizing simultaneous shooting of forward and rear source vessels to halve the CLO inline shot spacing.

The results of marine surveys that acquire survey data for FWI may be improved by utilizing low-frequency data having good signal-to-noise ratio. Improved equipment and methods for acquiring low-frequency data, low-noise data, and/or long-offset data would be beneficial.

### BRIEF DESCRIPTION OF THE DRAWINGS

So that the manner in which the features of the present disclosure can be understood in detail, a more particular description of the disclosure may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an exemplary embodiment of a marine geophysical survey system configured for long-offset acquisition.

FIG. 2 illustrates another exemplary embodiment of a marine geophysical survey system configured for long-offset acquisition.

FIG. 3 illustrates another exemplary embodiment of a marine geophysical survey system configured for long-offset acquisition.

FIG. 4 illustrates another exemplary embodiment of a marine geophysical survey system configured for long-offset acquisition.

FIG. 5 illustrates another exemplary embodiment of a marine geophysical survey system configured for long-offset acquisition.

FIG. 6 illustrates another exemplary embodiment of a marine geophysical survey system configured for long-offset acquisition.

FIG. 7 illustrates an exemplary concept of receiver grouping.

FIG. 8 illustrates a ghost function for seismic receivers towed at two different streamer depths.

FIG. 9 illustrates a ghost function for seismic receivers towed at three different streamer depths.

FIG. 10 illustrates relative differences in signal-to-noise ratio for three different scenarios for towing seismic receivers at long-offsets.

FIGS. 11A and 11B illustrate comparisons of noise for various receiver group lengths.

FIG. 12 illustrates a system for a long-offset surveying method.

FIG. 13 illustrates a machine for a long-offset acquisition method.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +−10% variation. The term “nominal” means as planned or designed in the absence of variables such as wind, waves, currents, or other unplanned phenomena. “Nominal” may be implied as commonly used in the field of marine surveying.

“Axial direction” shall mean, for an object or system having a canonical axis, a direction along a proximal portion of the axis.

“Lateral direction” shall mean, for an object or system having a canonical axis, a direction perpendicular to a proximal portion of the axis. Often, “lateral direction” is understood to be at a fixed depth.

“Inline direction” shall mean, for equipment towed by a vessel, a direction along (or parallel to) the path traversed by the vessel.

“Crossline direction” shall mean, for equipment towed by a vessel, a fixed-depth direction perpendicular to the path traversed by the vessel.

“Offset” shall mean the nominal inline distance between the source and the receiver.

“Cable” shall mean a flexible, axial load carrying member that also comprises electrical conductors and/or optical conductors for carrying electrical power and/or signals between components.

“Rope” shall mean a flexible, axial load carrying member that does not include electrical and/or optical conductors. Such a rope may be made from fiber, steel, other high strength material, chain, or combinations of such materials.

“ Line” shall mean either a rope or a cable.

“Source vessel” shall mean a watercraft, manned or unmanned, that is configured to carry and/or tow, and in practice does carry and/or tow, one or more geophysical sources. Source vessels may optionally be configured to tow one or more geophysical streamers.

“Streamer vessel” shall mean a watercraft, manned or unmanned, that is configured to tow one or more geophysical streamers. Unless otherwise specified, streamer vessels should be understood to not carry or tow one or more geophysical sources.

“Survey vessel” shall mean a source vessel or a streamer vessel.

“Buoyancy” of an object shall refer to buoyancy of the object taking into account any weight supported by the object.

“Forward” or “front” shall mean the direction or end of an object or system that corresponds to the intended primary direction of travel of the object or system.

“Aft” or “back” shall mean the direction or end of an object or system that corresponds to the reverse of the intended primary direction of travel of the object or system.

“Port” and “starboard” shall mean the left and right, respectively, direction or end of an object or system when facing in the intended primary direction of travel of the object or system.

“Obtaining” data shall mean any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

The term “simultaneous” does not necessarily mean that two or more events occur at precisely the same time or over exactly the same time period. Rather, as used herein, “simultaneous” means that the two or more events occur near in time or during overlapping time periods. For example, the two or more events may be separated by a short time interval that is small compared to the duration of the surveying operation. As another example, the two or more events may occur during time periods that overlap by about 40% to about 100% of either period.

Full wavefield inversion (FWI) refers to data acquisition and/or processing techniques that include simulating seismic source energy, propagating the energy (as a wavefield) through a model of the area being surveyed, making simulated measurements of the propagated energy, comparing the simulated seismic measurements with the actual seismic measurements, and iteratively updating the model according to a loss function based on the comparison. In some embodiments, the complexity of calculating the wavefield propagation may limit the amount of frequencies that are useful for FWI. In some embodiments, limiting the frequencies used in the simulation may increase the speed of calculating and/or the accuracy with which the iterative modeling converges. Consequently, marine surveying may advantageously collect data primarily representative of signals having the frequencies which are the most useful for FWI. For example, the desired frequencies may be lower frequencies, e.g. below 25 Hz, below 15 Hz, below 10 Hz, below 8 Hz, below 2 Hz, etc.

If there is any conflict in the usages of a word or term in this specification and one or more patent or other documents that may be incorporated herein by reference, the definitions that are consistent with this specification should be adopted for the purposes of understanding this disclosure.

The present disclosure generally relates to marine seismic and/or electromagnetic survey methods and apparatuses, and, at least in some embodiments, to novel surveying system configurations, and their associated methods of use.

One of the many potential advantages of the embodiments of the present disclosure is that low-frequency data (e.g., low-frequency seismic data) may be acquired with high signal-to-noise ratio (i.e., with low noise). Another potential advantage includes acquiring survey data at long offsets and/or group lengths (e.g., long-offset seismic data). Another potential advantage includes selection of towing depth and/or group length to produce a data set with desired frequency and noise characteristics. Another potential advantage includes acquiring long offset data, including low-frequency/long-offset data, useful for FWI. It should be appreciated that data acquired at standard survey offsets may be too noisy below about 3 Hz for FWI. Embodiments of the present disclosure can thereby be useful in the discovery and/or extraction of hydrocarbons from subsurface formations.

In some embodiments, long-offset streamers may be towed behind a standard-offset survey spread. In some embodiments, the offsets of the receivers on the long-offset streamers may be at least double the offsets of the receivers on the standard-offset survey spread. In some embodiments, the number of long-offset streamers may be much less than the number of streamers in the standard-offset survey spread. In some embodiments, the long-offset streamers may specifically acquire low-frequency data (e.g., low-frequency seismic signals).

At least one embodiment of the present disclosure can provide long-offset data for velocity model building using one or more towed streamers, for instance to provide low-frequency data for FWI. For example, deep targets may be imaged by utilizing long-offset/low-frequency data with FWI to generate a velocity model for imaging. At least one embodiment of the present disclosure can provide long-offset data using a towed streamer for velocity model building as an alternative to ocean bottom nodes, for instance by combining two-dimensional (2D) acquisition with a separate marine survey vessel at aft-ward of a marine three-dimensional (3D) survey vessel to provide increased offsets for FWI.

In some embodiments, long-offset (e.g., from about 10 km to about 40 km, or greater than about 12 km offset) surveying is utilized for FWI. In some embodiments, FWI may utilize data that is recorded at low frequencies and/or with low noise. Some embodiments may advantageously improve signal-to-noise ratio (S/N) of recorded data (compared to other acquisition and/or data processing means) by assembling (e.g., summing, averaging, normalizing) data from selected receiver groupings and/or towing recording sensors at various depths (e.g., about 20 m to about 100 m, or about 25 m to about 75 m, or about 45 m). For example, depending on the recording frequencies of interest, a different towing depth may be utilized, and/or a different recording group length may be selected.

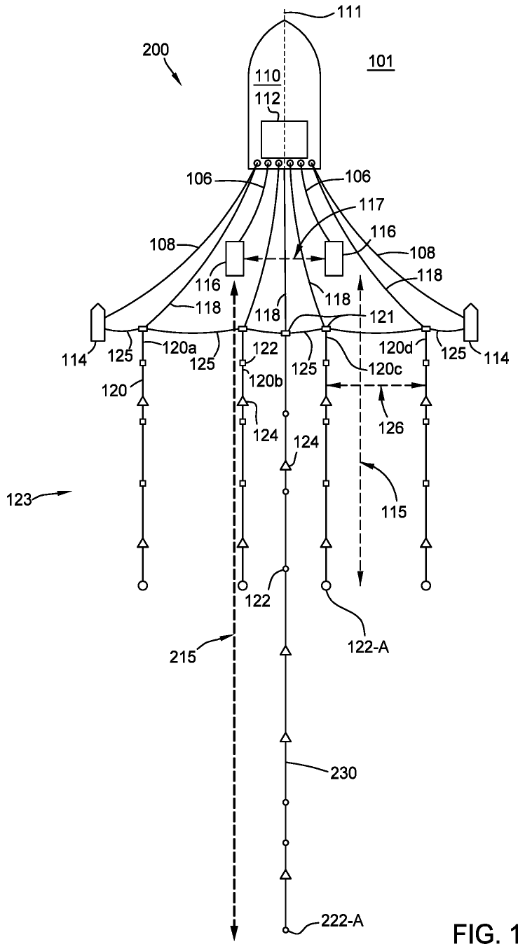

FIG. 1 illustrates an exemplary embodiment of a marine geophysical survey system 200 configured for long-offset acquisition. System 200 includes source vessel 110 that may be configured to move along a surface of body of water 101 (e.g., an ocean or a lake). In FIG. 1, source vessel 110 tows two signal sources 116, four standard streamers 120, and one long-offset streamer 230. As used herein, the term “signal source” or “source element” refers to an apparatus that is configured to emit a signal (e.g., acoustic, electromagnetic, etc.) that may be at least partially reflected from one or more subsurface structures, and then detected and/or measured. As used herein, the term “streamer” refers to an apparatus (e.g., a cable) that may be towed behind a survey vessel (e.g., a source vessel or a streamer vessel) to detect such signals, and thus may include detectors, sensors, receivers, and/or other structures (e.g., hydrophones, geophones, electrodes, etc.) positioned along or within the streamer and configured to detect and/or measure the reflected signal. “Survey data” generally refers to data utilized by and/or acquired during a survey, including detected signals, seismic data, electromagnetic data, pressure data, particle motion data, particle velocity data, particle acceleration data, clock data, position data, depth data, speed data, temperature data, etc. The standard streamers 120 may be of conventional length. For example, each standard streamer 120 may be about 5 km to about 12 km long, or in some embodiments about 8 km to about 10 km long. System 200 may utilize signal sources 116 with standard streamers 120 to acquire standard-offset survey data (i.e., data acquired at offsets less than about 12 km).

Signal sources 116 are shown in FIG. 1 being towed by source vessel 110 using source cables 106. Each of signal sources 116 may include sub-arrays of multiple individual signal sources. For example, signal source 116 may include a plurality of seismic sources, such as air guns or marine vibrators, and/or electromagnetic signal sources. As illustrated, the two signal sources 116 are distributed about a midline 111 of source vessel 110. The midline 111 represents the tow path along the centerline of the source vessel 110. As illustrated, the two signal sources 116 are distanced from one another by a nominal crossline source separation 117, which may be greater than, equal to, or less than nominal crossline streamer spacing 126. The signal sources 116 may be independently activated, activated simultaneously, activated in a sequential pattern, and/or activated randomly with respect to one another. In some embodiments (not shown), signal sources 116 may be distributed asymmetrically with respect to the midline 111 of source vessel 110.

Standard streamers 120 may include a variety of receivers 122. Receivers 122 may include seismic receivers or sensors, such as hydrophones, pressure sensors, geophones, particle motion sensors, and/or accelerometers. Receivers 122 may include electromagnetic sensors, such as electrodes or magnetometers. Receivers 122 may include any suitable combination of these and/or other types of geophysical sensors. Standard streamers 120 may further include streamer steering devices 124 (also referred to as “birds”) which may provide controlled lateral and/or vertical forces to standard streamers 120 as they are towed through the water, typically based on wings or hydrofoils that provide hydrodynamic lift. Standard streamers 120 may further include tail buoys (not shown) at their respective back ends. The number and distribution of receivers 122, streamer steering devices 124, and tail buoys along each standard streamer 120 may be selected in accordance with manufacturing and operational circumstances or preferences.

As illustrated in FIG. 1, standard streamers 120 are coupled to source vessel 110 via standard lead-in lines 118 and lead-in terminations 121. Standard lead-in lines 118 may generally be about 750 m to about 1500 m, or more specifically about 1000 m to about 1200 m in total length. Typically, about half of the total length of standard lead-in line 118 will be in the water. For example, about 400 m-500 m of standard lead-in line 118 may be in the water during operation. Lead-in terminations 121 may be coupled to or associated with spreader lines 125 so as to nominally fix the lateral positions of standard streamers 120 with respect to each other and with respect to a centerline of source vessel 110. Standard streamers 120a-120d may be nominally fixed in lateral positions with respect to each other in order to form a standard-offset survey spread 123 (e.g., a narrow azimuth spread, and/or a 3D acquisition spread) to collect standard-offset survey data as source vessel 110 traverses the surface of body of water 101. In a standard-offset survey spread 123, the nominal crossline streamer spacing 126 may range from about 25 m to about 200 m, or in some embodiments about 100 m. As shown, system 200 may also include two paravanes 114 coupled to source vessel 110 via paravane tow lines 108. Paravanes 114 may be used to provide a streamer separation force for standard-offset survey spread 123.

As illustrated in FIG. 1, standard-offset survey spread 123 may be towed at a nominal depth of about 10 m to about 30 m, or more particularly about 25 m. For example, the speed of source vessel 110, length of standard lead-in lines 118, angle of paravanes 114, length of spreader lines 125, and/or any steering devices, tail buoys, and/or depth control buoys may be configured and/or operated to tow the standard streamers 120 at a nominal depth of about 10 m to about 30 m. It should be appreciated that streamers are generally towed at a nominal depth that may vary (e.g., by about ±5%) along the length of the streamer due to environmental factors (e.g., currents, water temperatures).

In various embodiments, a geophysical survey system may include any appropriate number of towed signal sources 116 and standard streamers 120. For example, FIG. 1 shows two signal sources 116 and four standard streamers 120. It should be appreciated that standard-offset survey spread 123 commonly include as few as 2 and as many as 24 or more standard streamers 120, or in some embodiments ten standard streamers 120. In one embodiment, for example, source vessel 110 may tow eighteen or more standard streamers 120. A geophysical survey system with an increased number of signal sources 116 and/or standard streamers 120 may allow for more survey data to be collected and/or a wider standard-offset survey spread 123 to be achieved. The width of a survey spread may be determined by the crossline streamer spacing 126 and the number of streamers in the survey spread. For example, standard-offset survey spread 123 may have a width of about 300 m to about 3 km, or in some embodiments about 900 m.

Geodetic position (or “position”) of the various elements of system 200 may be determined using various devices, including navigation equipment such as relative acoustic ranging units and/or global navigation satellite systems (e.g., a global positioning system (GPS)).

Source vessel 110 may include equipment, shown generally at 112 and for convenience collectively referred to as a “recording system.” Recording system 112 may include devices such as a data recording unit (not shown separately) for making a record (e.g., with respect to time) of signals collected by various geophysical sensors. For example, in various embodiments, recording system 112 may be configured to record reflected signals detected or measured by receivers 122 while source vessel 110 traverses the surface of body of water 101. Recording system 112 may also include a controller (not shown separately), which may be configured to control, determine, and record, at selected times, navigation and/or survey data, including the geodetic positions of: source vessel 110, signal sources 116, standard streamers 120, receivers 122, etc. Recording system 112 may also include a communication system for communicating between the various elements of system 200, with other vessels, with on-shore facilities, etc.

As illustrated, standard-offset survey spread 123 has aft-most receivers 122-A. For example, each aft-most receiver 122-A may be at or near the aft-most end of a standard streamer 120. In the illustrated embodiment, an aft-most receiver 122-A is aft of each illustrated streamer steering device 124, but other configurations are possible. The inline distance between signal source 116 and aft-most receiver 122-A is the longest offset 115 of standard-offset survey spread 123. Typically, conventional marine geophysical survey spreads may have longest offsets of about 5 km to about 12 km, or in some embodiments about 8 km to about 10 km.

System 200 also includes a long-offset streamer 230. For example, each standard streamer 120 may be about 5 km to about 12 km long, while long-offset streamer 230 may be about 12 km to about 40 km long, or in some embodiments about 18 km to about 20 km long. As illustrated, long-offset streamer 230 is coupled to source vessel 110 via a standard lead-in line 118 and a lead-in termination 121. In some embodiments, the lead-in termination 121 of long-offset streamer 230 may be coupled to or associated with spreader lines 125 so as to nominally fix the lateral positions of long-offset streamers 230 with respect to standard streamers 120. As with standard streamers 120, long-offset streamer 230 may include receivers 122, streamer steering devices 124, and tail buoys. The number and distribution of receivers 122, streamer steering devices 124, and tail buoys along long-offset streamer 230 may be selected in accordance with manufacturing and operational circumstances or preferences. In some embodiments, receivers 122 on long-offset streamer 230 may be low-frequency seismic receivers configured to detect and/or measure low-frequency seismic signals (e.g., about 1 Hz to about 30 Hz, or about 1 Hz to about 8 Hz). In some embodiments, system 200 may have an aft-most receiver 222-A providing a longest offset 215 of about 12 km to about 40 km, or in some embodiments about 18 km to about 20 km. System 200 may utilize signal sources 116 with long-offset streamer 230 to acquire long-offset survey data (i.e., data acquired at offsets greater than about 12 km).

As would be appreciated by one of ordinary skill in the art with the benefit of this disclosure, long streamer cables (e.g., longer than about 12 km) can pose several challenges. For example, the axial strength of a standard streamer cable may not be sufficient to withstand the towing forces incurred by a long streamer cable. As another example, increasing the length of streamer cables may increase drag, and thereby increase operational costs. As another example, the capacity of data buses in a standard streamer cable may not be sufficient for the data expected from a long streamer cable. For example, a long streamer cable may have many more receivers than a standard streamer cable, each acquiring data to be carried by the data buses. As another example, data signals along data buses in long streamer cables may require repeaters to boost the signal along the length of the long streamer cable. As another example, the capacity of power lines and/or power sources in a standard streamer cable may not be sufficient for the power demands expected from a long streamer cable. Moreover, low-frequency/long-offset data may be less useful for conventional imaging, especially 3D imaging, compared to high-frequency data.

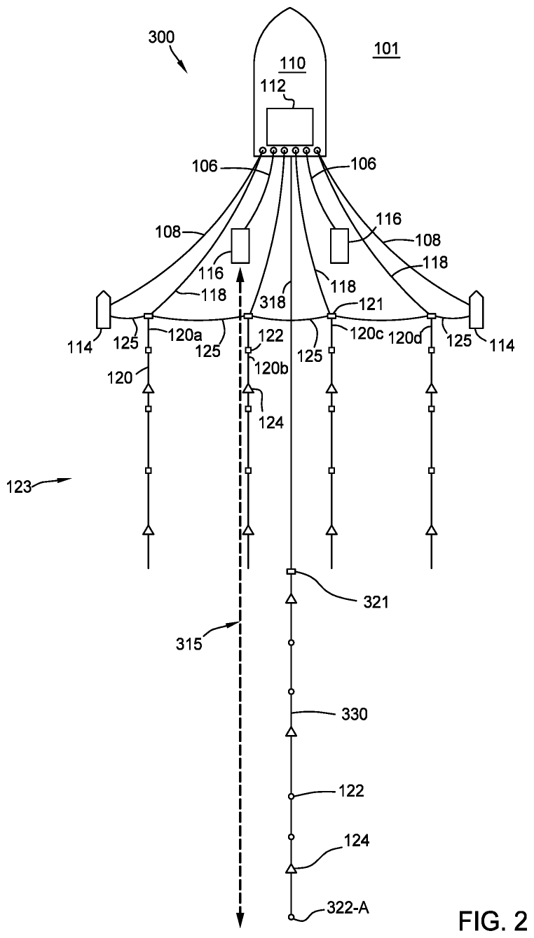

FIG. 2 illustrates another exemplary embodiment of a marine geophysical survey system 300 configured for long-offset acquisition. In many aspects, system 300 is configured similarly to system 200. However, system 300 includes a long-offset lead-in line 318 coupled between source vessel 110 and long-offset streamer 330. In FIG. 2, long-offset lead-in line 318 is not coupled to, and may be disposed at a different depth than, spreader lines 125. In some embodiments, long-offset lead-in line 318 may be about the same length as the length of a standard lead-in line 118 plus the length of a standard streamer 120. In some embodiments, long-offset lead-in line 318 may be longer or shorter than the combined length of standard lead-in line 118 and standard streamer 120. In some embodiments, long-offset streamer 330 may be about the same length as the length of a standard streamer 120. For example, long-offset lead-in line 318 may be about 5 km to about 20 km long, while long-offset streamer 330 may be about 5 km to about 20 km long. In some embodiments, long-offset streamer 330 may be longer or shorter than the length of standard streamer 120. Long-offset streamer 330 may be coupled to long-offset lead-in line 318 with a long-offset lead-in termination 321. For example, long-offset lead-in termination 321 may be configured to couple between long-offset lead-in line 318 and long-offset streamer 330 aft of standard-offset survey spread 123. In some embodiments, long-offset lead-in termination 321 may be configured to couple between long-offset lead-in line 318 and long-offset streamer 330 aft of an inline midpoint of standard-offset survey spread 123. As with standard streamers 120 and long-offset streamer 230, long-offset streamer 330 may include receivers 122, streamer steering devices 124, and tail buoys. The number and distribution of receivers 122, streamer steering devices 124, and tail buoys along long-offset streamer 330 may be selected in accordance with manufacturing and operational circumstances or preferences. In some embodiments, receivers 122 on long-offset streamer 330 may be low-frequency seismic receivers configured to detect and/or measure low-frequency seismic signals (e.g., about 1 Hz to about 8 Hz). In some embodiments, system 300 may have an aft-most receiver 322-A providing a longest offset 315 of about 10 km to about 40 km, or in some embodiments 20 km. In some embodiments, long-offset streamer 330 may be less than about 10 km in length, while longest offset 315 may be greater than about 12 km. For example, the length of long-offset lead-in line 318 may be about 5 km, the length of long-offset streamer 330 may be about 12 km, and longest offset 315 may be about 17 km. System 300 may utilize signal sources 116 with standard streamers 120 to acquire standard-offset survey data, and system 300 may utilize signal sources 116 with long-offset streamer 330 to acquire long-offset survey data.

In some embodiments, long-offset lead-in line 318 may be positively or neutrally buoyant (e.g., have more buoyancy than standard lead-in line 118). For example, long-offset lead-in line 318 may be configured to float at or near (e.g. no more than about 10 m below) the surface of body of water 101. In some embodiments, the long-offset lead-in line 318 may be made of and/or filled with buoyant material. In some embodiments, the long-offset lead-in line 318 may have floatation devices attached along its length. As would be understood by one of ordinary skill in the art with the benefit of this disclosure, buoyant long-offset lead-in lines may provide several advantages. Drag is always a concern when equipment is towed behind a survey vessel. The length of long-offset lead-in lines 318 may make drag a heightened concern. However, buoyant long-offset lead-in lines may reduce drag by reducing the surface area exposed to water while towing. Additionally, as previously discussed, spreader lines 125 may nominally fix the lateral positions of standard streamers 120 and their associated standard lead-in lines 118. However, long-offset lead-in line 318 may not be coupled to spreader lines 125. Entanglement of the lead-in lines may be avoided by towing standard lead-in lines 118 (and spreader lines 125) at a different depth than long-offset lead-in line 318. Since standard lead-in lines 118 are typically towed about 10 m to about 30 m depth (to match the towing depths of their associated standard streamers 120), a buoyant long-offset lead-in line 318 may mitigate entanglement risks.

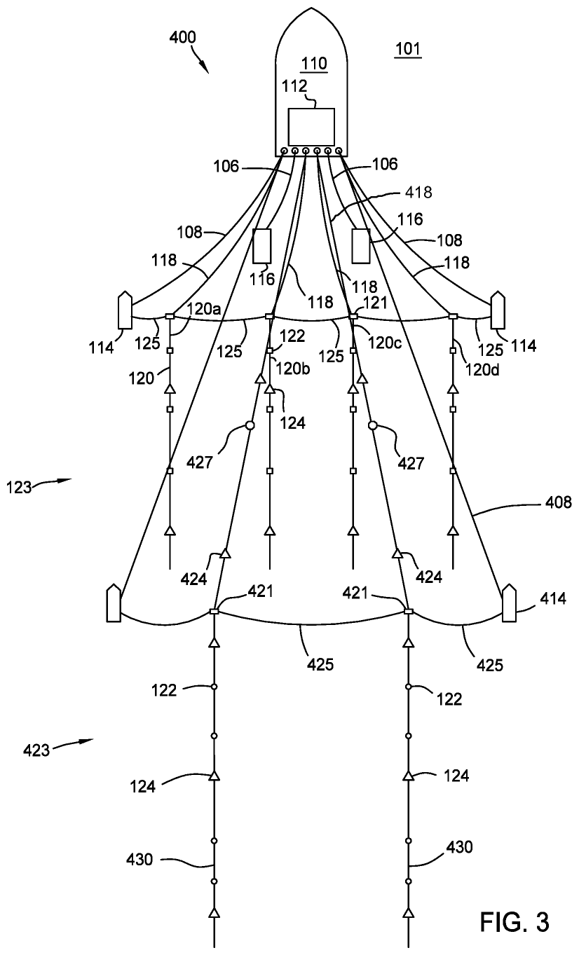

FIG. 3 illustrates another exemplary embodiment of a marine geophysical survey system 400 configured for long-offset acquisition. In many aspects, system 400 is configured similarly to systems 200 and 300. However, system 400 includes a long-offset survey spread 423 that includes two long-offset streamers 430. As illustrated, a long-offset lead-in line 418 couples between each of the long-offset streamers 430 and source vessel 110. Each of the long-offset streamers 430 may be coupled to the respective long-offset lead-in line 418 with a long-offset lead-in termination 421. For example, each long-offset lead-in termination 421 may be configured to couple between the respective long-offset lead-in line 418 and long-offset streamer 430 aft of standard-offset survey spread 123. In some embodiments, each long-offset lead-in termination 421 may be configured to couple between the respective long-offset lead-in line 418 and long-offset streamer 430 aft of an inline midpoint of standard-offset survey spread 123. Long-offset lead-in terminations 421 may be coupled to or associated with long-offset spreader lines 425 so as to nominally fix the lateral positions of long-offset streamers 430 with respect to each other and with respect to a centerline of source vessel 110. As shown, system 400 may also include two long-offset paravanes 414 coupled to source vessel 110 via long-offset paravane tow lines 408. Long-offset paravanes 414 may be used to provide a streamer separation force for long-offset survey spread 423. In the illustrated embodiment, long-offset spreader lines 425 are towed aft of standard-offset survey spread 123. In some embodiments (e.g., when standard-offset survey spread 123 and long-offset survey spread 423 are towed at different depths), long-offset spread lines 425 may be towed aft of spreader lines 125 but not aft of standard-offset survey spread 123. As with system 300, long-offset lead-in lines 418 are not coupled to, and may be disposed at a different depth than, spreader lines 125. As with standard streamers 120, long-offset streamer 230, and long-offset streamer 330, long-offset streamers 430 may include receivers 122, streamer steering devices 124, and tail buoys. The number and distribution of receivers 122, streamer steering devices 124, and tail buoys along each long-offset streamer 430 may be selected in accordance with manufacturing and operational circumstances or preferences. In some embodiments, receivers 122 on long-offset streamer 430 may be low-frequency seismic receivers configured to detect and/or measure low-frequency seismic signals (e.g., about 1 Hz to about 8 Hz). System 400 may utilize signal sources 116 with standard streamers 120 to acquire standard-offset survey data, and system 400 may utilize signal sources 116 with long-offset streamers 430 to acquire long-offset survey data.

In some embodiments, long-offset lead-in lines 418 may include one or more lead-in steering devices 424. Similar to streamer steering devices 124, lead-in steering devices 424 may provide controlled lateral and/or vertical forces to long-offset lead-in lines 418 as they are towed through the water.

In some embodiments, each long-offset lead-in line 418 may be coupled to a depth control buoy 427. For example, the depth control buoy 427 may be coupled to long-offset lead-in line 418 at, or forward of, long-offset lead-in termination 421. As another example, the depth control buoy 427 may be coupled to long-offset lead-in line 418 at, or forward of, spreader lines 125. As another example, the depth control buoy 427 may be coupled to long-offset lead-in line 418 near (e.g., within about 100 m) source vessel 110. Depth control buoy 427 may control the depth of a portion (e.g., the front end) of long-offset lead-in line 418. In some embodiments, depth control buoy 427 is coupled to long-offset lead-in line 418 by a remotely controlled (e.g. radio-controlled) winch. For example, depth control buoy 427 and any winch thereon may be managed from an instrument room onboard the source vessel 110. In some embodiments, the depth control buoy 427 may be configured to communicate with the source vessel 110 to provide remote control of the depth of the long-offset lead-in line 418, and/or remote monitoring of technical information about the depth control buoy 427, such as humidity and voltage. In some embodiments, the winch may be powered by an onboard power supply, which can include, for example, a battery and a power harvester, such as an underwater generator, that provides power to the battery, to allow the depth control buoy 427 to be towed without maintenance for several months at the time.

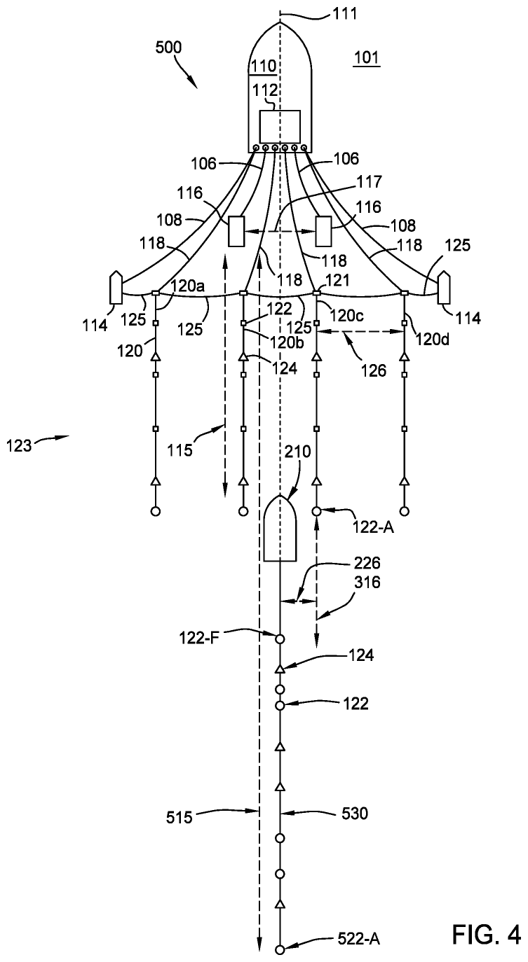

FIG. 4 illustrates another exemplary embodiment of a marine geophysical survey system 500 configured for long-offset acquisition. In many aspects, system 500 is configured similarly to system 200. However, system 500 includes a long-offset streamer 530 towed by long-offset streamer vessel 210. For example, each standard streamer 120 may be about 5 km to about 12 km long, while long-offset streamer 530 may be about 12 km to about 50 km long. As illustrated, long-offset streamer 530 is coupled to long-offset streamer vessel 210. For example, long-offset streamer 530 may be coupled to long-offset streamer vessel 210 via a lead-in line (not shown) and a lead-in termination (not shown). As with standard streamers 120, long-offset streamer 530 may include receivers 122, streamer steering devices 124, and/or tail buoys (not shown). The number and distribution of receivers 122, streamer steering devices 124, and/or tail buoys along long-offset streamer 530 may be selected in accordance with manufacturing and operational circumstances or preferences. In some embodiments, receivers 122 on long-offset streamer 530 may be low-frequency seismic receivers configured to detect and/or measure low-frequency seismic signals (e.g., about 1 Hz to about 30 Hz, or about 1 Hz to about 8 Hz). In some embodiments, system 500 may have an aft-most receiver 522-A providing a longest offset 515 of about 20 km to about 60 km, or in some embodiments about 30 km. System 500 may utilize signal sources 116 with standard streamers 120 to acquire standard-offset survey data, and system 500 may utilize signal sources 116 with long-offset streamer 530 to acquire long-offset survey data.

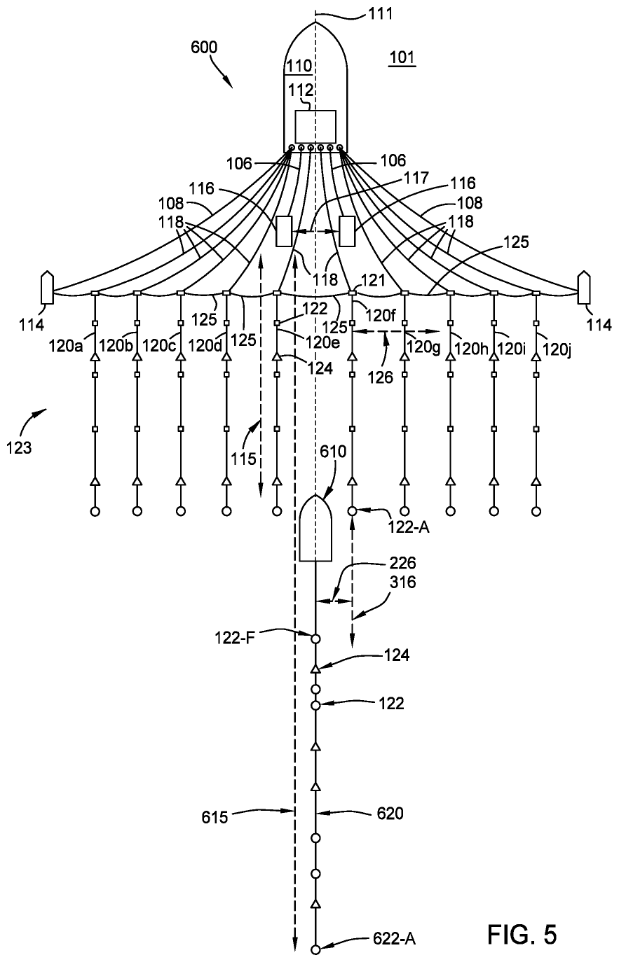

FIG. 5 illustrates another exemplary embodiment of a marine geophysical survey system 600 configured for long-offset acquisition. In many aspects, system 600 is configured similarly to system 500. However, system 600 includes ten standard streamers 120 in standard-offset survey spread 123, and an aft-ward standard streamer 620 towed by long-offset streamer vessel 610. In the illustrated embodiment, standard streamers 120 may be about 8 km long, and nominal crossline streamer spacing 126 may be about 100 m. For example, standard-offset survey spread 123 may be a standard narrow-azimuth survey configuration. Aft-ward standard streamer 620 may be about 5 km to about 12 km long, or in some embodiments about 8 km to about 10 km long. As illustrated, aft-ward standard streamer 620 is coupled to long-offset streamer vessel 610. For example, aft-ward standard streamer 620 may be coupled to long-offset streamer vessel 610 (e.g., a 2D survey vessel) via a lead-in line (not shown) and a lead-in termination (not shown). As with standard streamers 120, aft-ward standard streamer 620 may include receivers 122, streamer steering devices 124, and/or tail buoys (not shown). The number and distribution of receivers 122, streamer steering devices 124, and/or tail buoys along aft-ward standard streamer 620 may be selected in accordance with manufacturing and operational circumstances or preferences. In some embodiments, receivers 122 on aft-ward standard streamer 620 may be low-frequency seismic receivers configured to detect and/or measure low-frequency seismic signals (e.g., about 1 Hz to about 30 Hz, or about 1 Hz to about 8 Hz). In some embodiments, system 600 may have an aft-most receiver 622-A providing a longest offset 615 of about 10 km to about 24 km, or in some embodiments about 18 km. System 600 may utilize signal sources 116 with standard streamers 120 to acquire standard-offset survey data, and system 600 may utilize signal sources 116 with long-offset streamer 620 to acquire long-offset survey data.

In some embodiments, marine geophysical survey system 600 may be operated and/or configured to tow aft-ward standard streamer 620 at a different nominal depth than the standard streamers 120 of the standard-offset survey spread 123. For example, long-offset lead-in lines, winches, steering devices, tail buoys, depth control buoys, and/or survey vessel depths and/or speeds may be operated and/or configured to tow aft-ward standard streamer 620 at a nominal depth greater than 25 m, such as about 30 m to about 200 m, or more particularly at a depth of about 45 m or at a depth of about 75 m. In contrast, standard-offset survey spread 123 may be towed at a nominal depth of about 10 m to about 30 m, or more particularly about 25 m.

It should be appreciated that geophysical survey system 600 offers numerous advantages over existing technology. For example, the long offsets of receivers on aft-ward standard streamer 620 provide improved data quality for FWI. Compared to survey systems utilizing multiple source vessels to achieve long offsets, system 600 offers a reduced amount of equipment in the water, thereby reducing both costs and safety risks. Likewise, utilizing a 2D survey vessel to tow aft-ward standard streamer 620 reduces vessel effort and fuel costs. Utilizing a 2D survey vessel, rather than a second source vessel, reduces source expenses (e.g., air supply, navigation, data filtering, etc.), and reduces environmental impact. The long offsets available from receivers on aft-ward standard streamer 620 provide improved S/N over that available from the standard-offset survey spread 123.

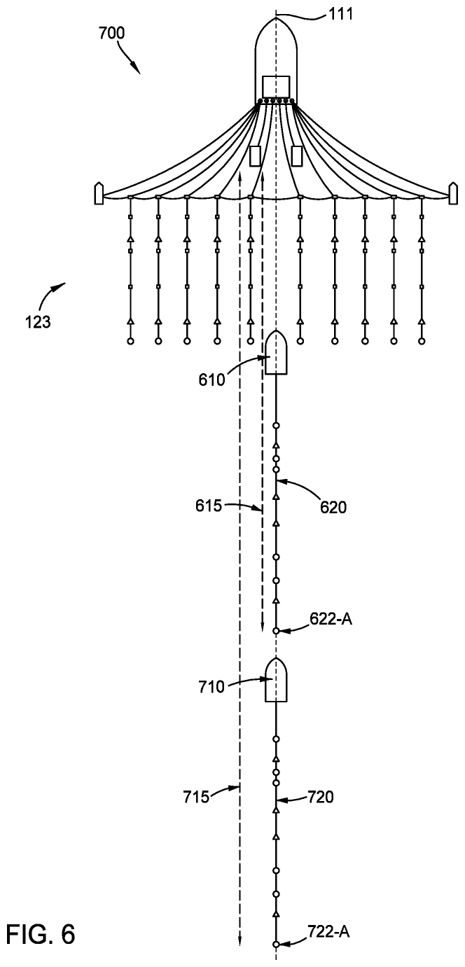

FIG. 6 illustrates another exemplary embodiment of a marine geophysical survey system 700 configured for long-offset acquisition. In many aspects, system 700 is configured similarly to system 600. However, system 700 includes an aft-ward standard streamer 720 towed by long-offset streamer vessel 710 in addition to aft-ward standard streamer 620 towed by long-offset streamer vessel 610. As illustrated, long-offset streamer vessel 710 may navigate a survey path that nominally follows inline and/or aft-ward of long-offset streamer vessel 610. In some embodiments, long-offset streamer vessel 710 may navigate a survey path that nominally follows aft-ward of aft-most receiver 622-A of aft-ward standard streamer 620. It should be appreciated that additional long-offset streamer vessels towing either long-offset streamers or standard streamers may be included in other embodiments. In some embodiments, each additional long-offset streamer vessel may navigate a survey path that nominally follows inline and/or aft-ward of a forward-most streamer vessel. Aft-ward standard streamer 720 may be about 5 km to about 12 km long, or in some embodiments about 8 km to about 10 km long. As illustrated, aft-ward standard streamer 720 is coupled to long-offset streamer vessel 710. For example, aft-ward standard streamer 720 may be coupled to long-offset streamer vessel 710 via a lead-in line (not shown) and a lead-in termination (not shown). As with standard streamers 120, aft-ward standard streamer 720 may include receivers 122, streamer steering devices 124, and/or tail buoys (not shown). The number and distribution of receivers 122, streamer steering devices 124, and/or tail buoys along aft-ward standard streamer 720 may be selected in accordance with manufacturing and operational circumstances or preferences. In some embodiments, receivers 122 on aft-ward standard streamer 720 may be low-frequency seismic receivers configured to detect and/or measure low-frequency seismic signals (e.g., about 1 Hz to about 30 Hz, or about 1 Hz to about 8 Hz). In some embodiments, system 700 may have an aft-most receiver 722-A providing a longest offset 715 of about 15 km to about 36 km, or in some embodiments about 30 km. System 700 may utilize signal sources 116 with standard streamers 120 to acquire standard-offset survey data, and system 700 may utilize signal sources 116 with long-offset streamer 620 and long-offset streamer 720 to acquire long-offset survey data.

In some embodiments, communications equipment may be associated with long-offset streamer 530, aft-ward standard streamer 620, and/or aft-ward standard streamer 720 for communicating (e.g., wirelessly) among various elements of the long-offset and/or aft-ward streamer(s), the system(s), other vessels, on-shore facilities, etc. For example, communications equipment may be included as a component of the long-offset streamer vessel, of the tail buoy(s), or of any other component associated with the long-offset and/or aft-ward streamer(s). The communications equipment may provide data communications between components of the system(s), such as between receivers 122 of the long-offset and/or aft-ward streamer(s) and recording system 112 of source vessel 110. For example, communications equipment may be useful for synchronizing shot times from signal sources 116 with recording times for data acquired by receivers 122 and/or recorded on the long-offset streamer vessel(s).

In some embodiments, long-offset streamer vessel 210, 610, 710 may be an unmanned watercraft, such as a remotely-operated vehicle (ROV) and/or a depth control buoy. For example, the long-offset streamer vessel(s) may control the position and/or depth of a portion (e.g., the front end) of the long-offset and/or aft-ward streamer(s) and/or any lead-in line coupled thereto. In some embodiments, the long-offset streamer vessel(s) is coupled to the long-offset and/or aft-ward streamer(s) by a remotely controlled (e.g. radio-controlled) winch. For example, the long-offset streamer vessel(s) and any winch thereon may be managed from an instrument room onboard the source vessel 110. In some embodiments, the long-offset streamer vessel(s) may be configured to communicate with the source vessel 110. For example, the long-offset streamer vessel(s) may be configured to communicate with the source vessel 110 to share data (e.g., survey data, seismic data, clock data, real-time data, and/or asynchronous uploaded data), to provide remote control of the position and/or depth of the long-offset and/or aft-ward streamer(s), and/or remote monitoring of technical information about the long-offset streamer vessel(s), such as humidity and voltage. In some embodiments, the long-offset streamer vessel(s) and any winch thereon may be powered by an onboard power supply, which can include, for example, a battery and a power harvester, such as an underwater generator, that provides power to the battery, to allow the long-offset streamer vessel(s) to be operated without maintenance for several months at the time.

In some embodiments, marine geophysical survey system 700 may be operated and/or configured to tow aft-ward standard streamer 620 and/or aft-ward standard streamer 720 at different nominal depths than the standard streamers 120 of the standard-offset survey spread 123. For example, long-offset lead-in lines, winches, steering devices, tail buoys, depth control buoys, and/or survey vessel depths and/or speeds may be operated and/or configured to tow aft-ward standard streamer 620 and/or aft-ward standard streamer 720 at nominal depths greater than 25 m, such as about 30 m to about 100 m, or more particularly at a depth of about 45 m or at a depth of about 75 m. In contrast, standard-offset survey spread 123 may be towed at a nominal depth of about 10 m to about 30 m, or more particularly about 25 m.

As illustrated, each of systems 500, 600, 700 may be configured and/or operated so that long-offset streamer 530, aft-ward standard streamer 620, and/or aft-ward standard streamer 720 are towed along a midline 111 of the path of source vessel 110. The crossline spread separation 226 may be expressed as a crossline distance between the long-offset and/or aft-ward streamer(s) and a nearest standard streamer 120 of standard-offset survey spread 123. In some embodiments, the crossline spread separation may be from about 0 m (e.g., in the case of a midline standard streamer 120) to about 100 m, or in some embodiments about 50 m. For example, long-offset streamer vessel(s) may navigate a survey path that nominally follows the survey path of source vessel 110. As another example, any streamer steering devices 124 associated with the long-offset and/or aft-ward streamer(s) may cause the long-offset and/or aft-ward streamer(s) to nominally follow along the midline 111 of the path of source vessel 110. Likewise, in some embodiments, the system(s) may be configured and/or operated so that the long-offset and/or aft-ward streamer(s) are towed along a midline of the distributed signal sources 116. Likewise, in some embodiments, the system(s) may be configured and/or operated so that the long-offset and/or aft-ward streamer(s) are towed along a midline of the standard-offset survey spread 123.

In some embodiments, each of systems 500, 600, 700 may be configured and/or operated so that the long-offset and/or aft-ward streamer(s) are towed port-ward or starboard-ward of a midline of the path of source vessel 110, the distributed signal sources 116, and/or the standard-offset survey spread 123. For example, the long-offset and/or aft-ward streamer(s) may be towed between the midline of standard-offset survey spread 123 and an outermost (i.e., either port-most or starboard-most) standard streamers 120 thereof. In some embodiments, the long-offset and/or aft-ward streamer(s) may be towed outside of standard-offset survey spread 123 (i.e., either port of the port-most, or starboard of the starboard-most, standard streamers 120 thereof). In some embodiments, the long-offset streamer vessel(s) may be operated to navigate a survey path that does not nominally follow the survey path of source vessel 110, for example, to provide extended azimuthal and/or offset coverage.

As illustrated, each of systems 500, 600, 700 may be configured and/or operated so that long-offset streamer 530, aft-ward standard streamer 620, and/or aft-ward standard streamer 720 are towed near (e.g., within about 100 m) or at the aft-most point of standard-offset survey spread 123. The inline spread separation 316 may be expressed as an inline distance between an aft-most receiver 122-A of standard-offset survey spread 123 and a forward-most receiver 122-F of long-offset streamer 530 or aft-ward standard streamer 620, as the case may be. In some embodiments, the inline spread separation may be from about −1 km to about 100 m. For example, long-offset streamer vessel 210 may navigate a survey path that nominally remains aft-ward of the aft-most point of standard-offset survey spread 123.

In some embodiments, long-offset streamer 530, aft-ward standard streamer, and/or aft-ward standard streamer 720 are disposed at a different depth than standard-offset survey spread 123. For example, the long-offset and/or aft-ward streamer(s) may have a nominal towing depth of greater than 25 m, such as about 30 m to about 100 m, or more particularly at a depth of about 45 m or at a depth of about 75 m, while standard-offset survey spread 123 may have a nominal towing depth of about 10 m to about 30 m, or more particularly about 25 m. As would be understood by one of ordinary skill in the art with the benefit of this disclosure, seismic streamers have been typically towed at shallow depths (e.g., about 10 m-about 15 m) due to concerns about streamer ghost notches in the amplitude spectrum within the seismic frequency range. The nominal towing depth may be achieved by one or more of: operating the long-offset streamer vessel(s) at a selected depth, constructing and/or adapting the long-offset and/or aft-ward streamer(s) to be neutrally buoyant at a particular depth, equipping the long-offset and/or aft-ward streamer(s) with one or more depth control devices (e.g., depressors) distributed at one or more points along the length of the long-offset and/or aft-ward streamer(s), and/or utilizing a tail buoy with active and/or passive depth control. In some embodiments, towing the long-offset and/or aft-ward streamer(s) at a greater depth may provide improved low-frequency-data acquisition, possibly at the expense of high frequency data acquisition by receivers 122 on the long-offset and/or aft-ward streamer(s). It is currently believed that low-frequency/long-offset data may be more beneficial in than high-frequency/long-offset data for purposes such as FWI.

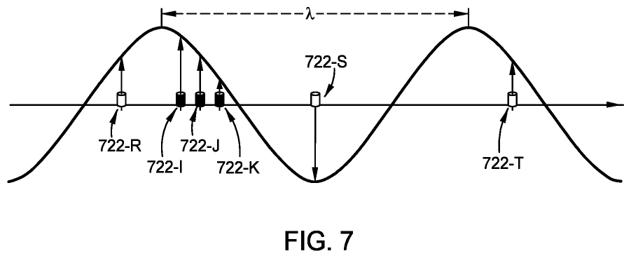

FIG. 7 illustrates an exemplary concept of receiver grouping. As illustrated, receivers 722-I,J,K are spaced closely together relative to the signal wavelength A. In other words, the group length (the inline distance between receiver 722-I and 722-K) is short. Thus, summing data of receivers 722-I,J,K will produce an additive response, thereby increasing the S/N (assuming that the noise is incoherent with respect to the signal wavelength). On the other hand, receivers 722-R,S,T are spaced at distances on the same order as A. In other words, the group length (the inline distance between receiver 722-R and 722-T) is long. Thus, summing data of receivers 722-R,S,T will produce diminished response, thereby not improving the S/N. According to Nyquist sampling theory, receivers must detect at least half of the spatial sampling of a signal to prevent aliasing. Commonly, seismic data is recorded at group lengths on the order of about 3 m to about 15 m, which improves S/N for signals having frequencies on the order of 60 Hz. However, for signals having frequencies of less than about 15 Hz, receiver group lengths may be greater than about 12.5 m, extending to about 50 m, or even to about 100 m.

In the illustrated embodiment of FIG. 6, aft-ward standard streamer 620 may have 200 non-overlapping receiver groupings, each having a 50 m group length (assuming the length of aft-ward standard streamer 620 is 10 km). Note that overlapping receiver groupings are also possible. In some embodiments, receiver groupings may be hard-wired. For example, a data bus may connect each receiver in a particular receiver group, and/or a memory storage unit and/or communications port may be associated with that particular receiver group. In some embodiments, receiver groupings may be determined as data is collected. For example, recording system 112 may collect data from various receivers, and sort the data into receiver groupings based on identification and/or positional information of each receiver. In some embodiments, receiver groupings may be determined as data is pre-processed. For example, raw survey data may be stored as a part of a data library, and obtaining data from the data library includes a function of setting a group length (or group length function, such as varying by offset) while reading the data into the pre-processing system. In some embodiments, assembling receiver data may include summing raw data from each receiver in the group. In some embodiments, assembling receiver data may include averaging raw data from each receiver in the group. In some embodiments, assembling receiver data may include normalizing group data from various receiver groupings.

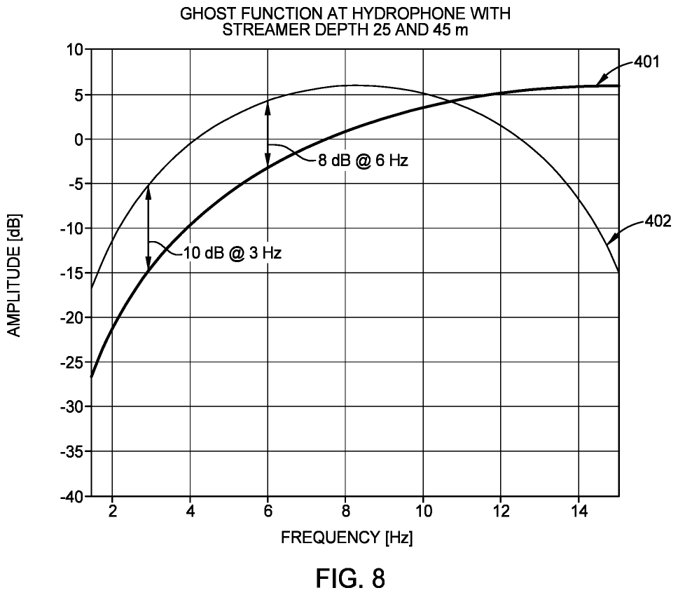

FIG. 8 illustrates a ghost function for seismic receivers (e.g., hydrophones) towed at two different streamer depths: 25 m (line 401) and 45 m (line 402). As illustrated, the vertical axis represents amplitude in decibels, and the horizontal axis represents frequency in hertz. It can be seen that the signals differ by about 10 dB at 3 Hz, and by about 8 dB at 6 Hz. In order to manage the ghost function when towing receivers at long-offsets (e.g., with long-offset streamers and/or aft-ward standard streamers), some embodiments may process the receiver data by summing together four receiver groupings (e.g., 50 m group lengths). Summing the four receiver groupings may advantageously provide minimal aliasing below 15 Hz. Moreover, the noise may be estimated as the square root of four (the number of groups summed). Therefore, in this instance, the noise floor may be lowered by about 6 dB. Likewise, in order to manage the ghost function when towing receivers at long-offsets (e.g., with long-offset streamers and/or aft-ward standard streamers), some embodiments may tow the long-offset streamers and/or aft-ward standard streamers at about 45 m depth, while towing the standard-offset streamers at depth of about 25 m. By towing the receivers at about 45 m depth, the S/N may be advantageously improved by about 5 dB to about 10 dB in frequency ranges from about 3 Hz to about 8 Hz, at least in part due to the ghost function. In some embodiments, the S/N may be improved by about 11 dB to about 16 dB for frequency ranges from about 3 Hz to about 8 Hz, thereby rivaling S/N achievable by ocean bottom nodes.

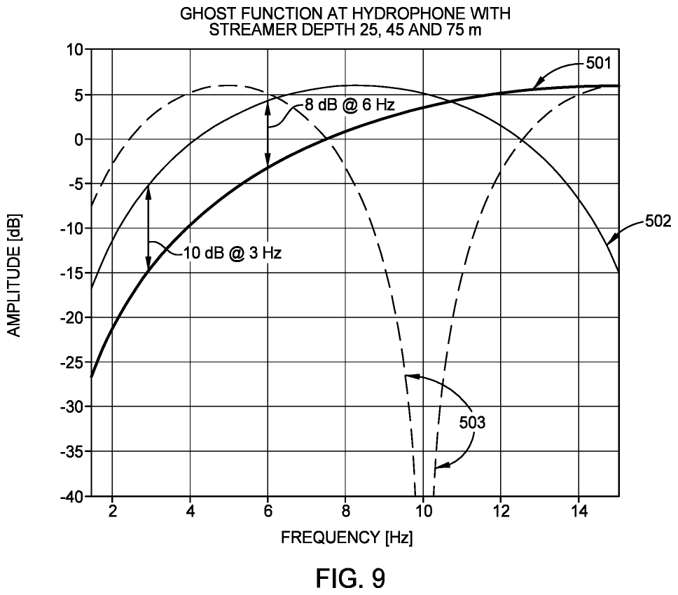

FIG. 9 illustrates a ghost function for seismic receivers towed at three different streamer depths: 25 m (line 501), 45 m (line 502), and 75 m (lines 503). As illustrated, the vertical axis represents amplitude in decibels, and the horizontal axis represents frequency in hertz. It can be seen that the signals differ by about 10 dB at 3 Hz, and by about 8 dB at 6 Hz. In order to manage the ghost function when towing receivers at long-offsets, some embodiments may process the receiver data by summing together eight receiver groupings (e.g., 100 m group lengths). Summing the eight receiver groupings may advantageously provide minimal aliasing below 7.5 Hz. Moreover, the noise may be estimated as the square root of eight (the number of groups summed). Therefore, in this instance, the noise floor may be lowered by about 9 dB. Likewise, in order to manage the ghost function when towing receivers at long-offsets, some embodiments may tow long-offset streamers and/or aft-ward standard streamers at 75 m depth, while towing the standard-offset streamers at 25 m depth. By towing the receivers at 75 m depth, the S/N may be advantageously improved by about 8 dB to about 17 dB in frequency ranges from about 2 Hz to about 6 Hz, at least in part due to the ghost function. In some embodiments, the S/N may be improved by about 17 dB to about 26 dB for frequency ranges from about 2 Hz to about 6 Hz, thereby rivaling S/N achievable by ocean bottom nodes.

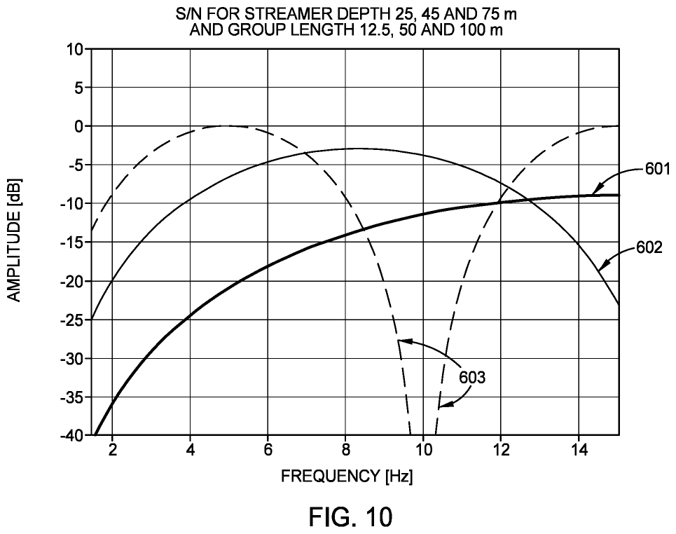

FIG. 10 illustrates relative differences in S/N for three different scenarios for towing seismic receivers at long-offsets. One scenario shows the S/N for towing a group of receivers having a group length of about 12.5 m at a depth of about 25 m (line 601). Another scenario shows the S/N for towing a group of receivers having a group length of about 50 m at a depth of about 45 m (line 602). Yet another scenario shows the S/N for towing a group of receivers having a group length of about 75 m at a depth of about 100 m (lines 603).

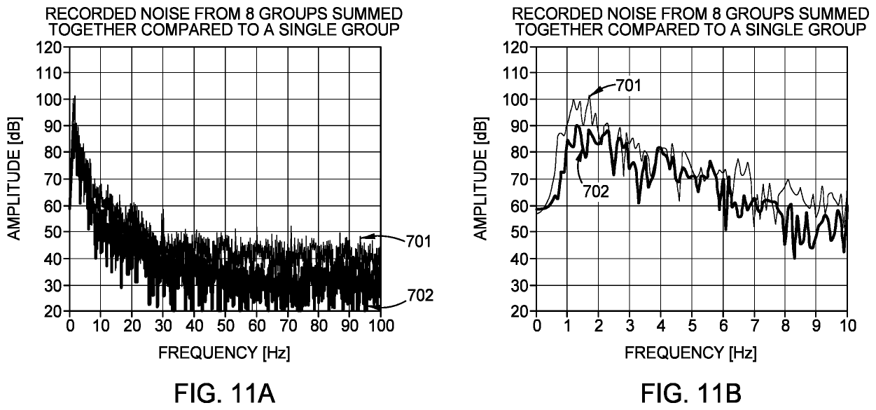

FIGS. 11A and 11B illustrate comparisons of noise (as a function of frequency) for receiver group lengths of about 12.5 m to receiver group lengths of about 100 m. As illustrated, the vertical axis represents amplitude in decibels, and the horizontal axis represents frequency in hertz. Line 701 illustrates the noise present after summing data over receiver group lengths of about 12.5 m. Line 702 illustrates the noise present after summing data over receiver group lengths of about 100 m (e.g., by summing data from eight receiver groupings, each having a receiver group length of about 12.5 m). FIG. 11B is a close-up of FIG. 11A in the range of 0-10 Hz. Note that the noise amplitude is significantly higher for the 12.5 m receiver group length, and the difference is on the order of 10 dB in much of the spectrum below 10 Hz.

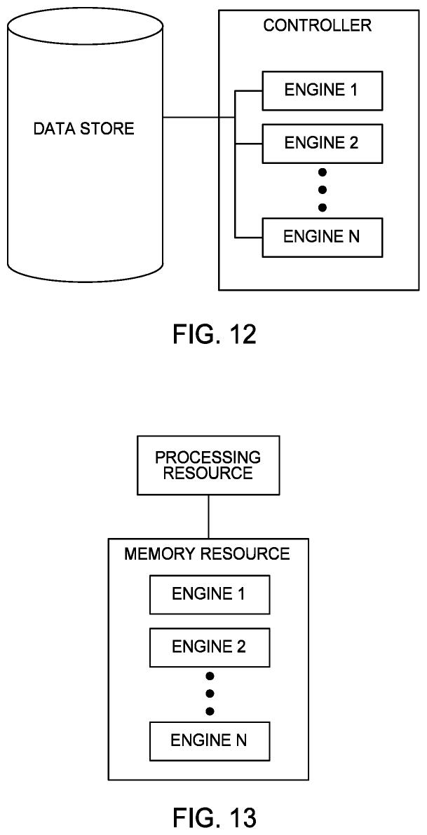

FIG. 12 illustrates a system for a long-offset surveying method. The system can include a data store and a controller coupled to the data store. The controller can be analogous to the controller described with respect to FIG. 1. The data store can store marine seismic survey data.

The controller can include a number of engines (e.g., engine 1, engine 2, . . . engine N) and can be in communication with the data store via a communication link. The system can include additional or fewer engines than illustrated to perform the various functions described herein. As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, etc.

The number of engines can include a combination of hardware and program instructions that is configured to perform a number of functions described herein. The program instructions, such as software, firmware, etc., can be stored in a memory resource such as a machine-readable medium or as a hard-wired program such as logic. Hard-wired program instructions can be considered as both program instructions and hardware.

The controller can be configured, for example, via a combination of hardware and program instructions in the number of engines for a long-offset acquisition method. For example, a first engine (e.g., engine 1) can be configured to actuate sources, process data, and/or acquire data gathered during acquisition using a long-offset acquisition configuration and method.

FIG. 13 illustrates a machine for a long-offset acquisition method. In at least one embodiment, the machine can be analogous to the system illustrated in FIG. 12. The machine can utilize software, hardware, firmware, and/or logic to perform a number of functions. The machine can be a combination of hardware and program instructions configured to perform a number of functions (e.g., actions). The hardware, for example, can include a number of processing resources and a number of memory resources, such as a machine-readable medium or other non-transitory memory resources. The memory resources can be internal and/or external to the machine, for example, the machine can include internal memory resources and have access to external memory resources. The program instructions, such as machine-readable instructions, can include instructions stored on the machine-readable medium to implement a particular function. The set of machine-readable instructions can be executable by one or more of the processing resources. The memory resources can be coupled to the machine in a wired and/or wireless manner. For example, the memory resources can be an internal memory, a portable memory, a portable disk, and/or a memory associated with another resource, for example, enabling machine-readable instructions to be transferred and/or executed across a network such as the Internet. As used herein, a “module” can include program instructions and/or hardware, but at least includes program instructions.

The memory resources can be tangible and/or non-transitory, and can include volatile and/or non-volatile memory. Volatile memory can include memory that depends upon power to store information, such as various types of dynamic random-access memory among others. Non-volatile memory can include memory that does not depend upon power to store information. Examples of non-volatile memory can include solid state media such as flash memory, electrically erasable programmable read-only memory, phase change random access memory, magnetic memory, optical memory, and/or a solid-state drive, etc., as well as other types of non-transitory machine-readable media.

The processing resources can be coupled to the memory resources via a communication path. The communication path can be local to or remote from the machine. Examples of a local communication path can include an electronic bus internal to a machine, where the memory resources are in communication with the processing resources via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path can be such that the memory resources are remote from the processing resources, such as in a network connection between the memory resources and the processing resources. That is, the communication path can be a network connection. Examples of such a network connection can include a local area network, wide area network, personal area network, and the Internet, among others.

Although not specifically illustrated in FIG. 13, the memory resources can store marine seismic survey data. As is shown in FIG. 13, the machine-readable instructions stored in the memory resources can be segmented into a number of modules (e.g., module 1, module 2, . . . module N) that when executed by the processing resources can perform a number of functions. As used herein a module includes a set of instructions included to perform a particular task or action. The number of modules can be sub-modules of other modules. For example, module 1 can be a sub-module of module 2. Furthermore, the number of modules can comprise individual modules separate and distinct from one another. Examples are not limited to the specific modules illustrated in FIG. 13.

In at least one embodiment of the present disclosure, a first module (e.g., module 1) can include program instructions and/or a combination of hardware and program instructions that, when executed by a processing resource, can actuate sources, process data, and/or acquire data gathered during acquisition using a long-offset acquisition configuration and method.

The methods and systems described herein may be used to manufacture a geophysical data product indicative of certain properties of a subterranean formation. The geophysical data product may include geophysical data such as survey data, seismic data, electromagnetic data, pressure data, particle motion data, particle velocity data, particle acceleration data, and any seismic image that results from using the methods and systems described above. The geophysical data product may be stored on a tangible and/or non-transitory computer-readable medium as described above. The geophysical data product may be produced offshore (i.e., by equipment on the survey vessel) or onshore (i.e., at a computing facility on land) either within the United States or in another country. When the geophysical data product is produced offshore or in another country, it may be imported onshore to a data-storage facility in the United States. Once onshore in the United States, geophysical analysis may be performed on the geophysical data product.

In accordance with a number of embodiments of the present disclosure, a geophysical data product may be produced. The geophysical data product may include, for example, low-frequency and/or long-offset survey data. Geophysical data, such as data previously collected by seismic sensors, electromagnetic sensors, depth sensors, location sensors, etc., may be obtained (e.g., retrieved from a data library) and may be recorded on a non-transitory, tangible computer-readable medium. The geophysical data product may be produced by processing the geophysical data offshore (i.e. by equipment on a vessel) or onshore (i.e. at a facility on land) either within the United States or in another country. If the geophysical data product is produced offshore or in another country, it may be imported onshore to a facility in the United States. In some instances, once onshore in the United States, geophysical analysis, including further data processing, may be performed on the geophysical data product. In some instances, geophysical analysis may be performed on the geophysical data product offshore, for example, FWI.

In an embodiment, a geophysical data product stored on a non-transitory computer-readable medium is produced by a process of: acquiring standard-offset survey data for a subterranean formation with a standard-offset survey spread towed at a standard-offset spread depth; acquiring long-offset survey data for the subterranean formation with a long-offset streamer towed at a long-offset streamer depth; and assembling the long-offset survey data into a set of grouped-long-offset survey data characterized by a plurality of receiver groupings and a group length.

In one or more embodiments disclosed herein, the standard-offset spread depth is from 10 m to 30 m.

In one or more embodiments disclosed herein, the long-offset streamer depth is from 30 m to 200 m.

In one or more embodiments disclosed herein, the group length is greater than 12.5 m.

In one or more embodiments disclosed herein, the assembling comprises, for each receiver grouping, summing data from a plurality of receivers in the receiver grouping.

In one or more embodiments disclosed herein, the assembling comprises, for each receiver grouping, averaging data from a plurality of receivers in the receiver grouping.

In one or more embodiments disclosed herein, the assembling comprises normalizing data from at least two different receiver groupings.

In one or more embodiments disclosed herein, the process further comprises producing a geophysical data set representative of signals having frequencies less than 15 Hz.

In one or more embodiments disclosed herein, a longest-offset of the long-offset streamer is at least 3 km longer than a longest-offset of the standard-offset survey spread.

In one or more embodiments disclosed herein, acquiring the standard-offset survey data comprises towing the standard-offset survey spread with a vessel, and acquiring the long-offset survey data comprises towing the long-offset streamer along a midline of a path of the vessel.

In one or more embodiments disclosed herein, the process further includes: producing a geophysical data set consisting of frequencies less than 8 Hz; and performing Full Wavefield Inversion with the geophysical data set to generate a velocity model.

In one or more embodiments disclosed herein, the process further includes: producing an image of the subterranean formation; and recording the image on a non-transitory, tangible computer-readable medium.

In one or more embodiments disclosed herein, the process further includes: bringing the computer-readable medium onshore; and performing geophysical analysis onshore on the image.

In one or more embodiments disclosed herein, the standard-offset survey spread comprises seismic receivers.

In one or more embodiments disclosed herein, the long-offset streamer comprises low-frequency seismic receivers.

In one or more embodiments disclosed herein, the long-offset streamer is at least 12 km in length.

In one or more embodiments disclosed herein, the standard-offset survey spread comprises a plurality of standard streamers, each of the standard streamers being no more than 12 km in length.

In an embodiment, a method, includes: towing a standard-offset survey spread at a standard-offset spread depth; acquiring standard-offset survey data for a subterranean formation with the standard-offset survey spread; towing a long-offset streamer with a long-offset vessel at a long-offset streamer depth; acquiring long-offset survey data for the subterranean formation with the long-offset streamer; and assembling the long-offset survey data into a set of grouped-long-offset survey data characterized by a plurality of receiver groupings and a group length.

In one or more embodiments disclosed herein, the standard-offset spread depth is from 10 m to 30 m.

In one or more embodiments disclosed herein, the long-offset streamer depth is from 30 m to 200 m.

In one or more embodiments disclosed herein, the group length is greater than 12.5 m.

In one or more embodiments disclosed herein, the assembling comprises, for each receiver grouping, summing data from a plurality of receivers in the receiver grouping.

In one or more embodiments disclosed herein, the assembling comprises, for each receiver grouping, averaging data from a plurality of receivers in the receiver grouping.

In one or more embodiments disclosed herein, the method further includes producing a geophysical data set representative of signals having frequencies less than 15 Hz.

In one or more embodiments disclosed herein, a longest-offset of the long-offset streamer is at least 3 km longer than a longest-offset of the standard-offset survey spread.

In one or more embodiments disclosed herein, the standard-offset survey spread is towed with a standard-offset vessel, and the long-offset streamer is towed along a midline of a path of the standard-offset vessel.

In one or more embodiments disclosed herein, the method further includes: producing a geophysical data set consisting of frequencies less than 8 Hz; and performing Full Wavefield Inversion with the geophysical data set to generate a velocity model.

In one or more embodiments disclosed herein, the method further includes: producing an image of the subterranean formation; and recording the image on a non-transitory, tangible computer-readable medium.

In one or more embodiments disclosed herein, further includes: bringing the computer-readable medium onshore; and performing geophysical analysis onshore on the image.

In one or more embodiments disclosed herein, the standard-offset survey spread comprises seismic receivers.

In one or more embodiments disclosed herein, the long-offset streamer comprises low-frequency seismic receivers.

In one or more embodiments disclosed herein, the long-offset streamer is at least 12 km in length.

In one or more embodiments disclosed herein, the standard-offset survey spread comprises a plurality of standard streamers, each of the standard streamers being no more than 12 km in length.

While the foregoing is directed to embodiments of the present disclosure, other and further embodiments of the disclosure may be devised without departing from the basic scope thereof, and the scope thereof is determined by the claims that follow.

1. A geophysical data product stored on a non-transitory computer-readable medium, wherein the geophysical data product is produced by a process of:
acquiring standard-offset survey data for a subterranean formation with a standard-offset survey spread towed at a standard-offset spread depth;
acquiring long-offset survey data for the subterranean formation with a long-offset streamer towed at a long-offset streamer depth; and
assembling the long-offset survey data into a set of grouped-long-offset survey data characterized by a plurality of receiver groupings and a group length of greater than 12.5 m.

2. The geophysical data product of claim 1, wherein:
the standard-offset spread depth is from 10 m to 30 m, and the long-offset streamer depth is from 30 m to 200 m.

3. The geophysical data product of claim 1, wherein the assembling comprises at least one of the following three sub-processes:
(1) for each receiver grouping, summing data from a plurality of receivers in the receiver grouping;
(2) for each receiver grouping, averaging data from a plurality of receivers in the receiver grouping; and
(3) normalizing data from at least two different receiver groupings.

4. The geophysical data product of claim 1, wherein the process further comprises producing a geophysical data set representative of signals having frequencies less than 15 Hz.

5. The geophysical data product of claim 1, wherein a longest-offset of the long-offset streamer is at least 3 km longer than a longest-offset of the standard-offset survey spread.

6. The geophysical data product of claim 1, wherein:
acquiring the standard-offset survey data comprises towing the standard-offset survey spread with a vessel, and
acquiring the long-offset survey data comprises towing the long-offset streamer along a midline of a path of the vessel.

7. The geophysical data product of claim 1, wherein the process further comprises:
producing a geophysical data set consisting of frequencies less than 8 Hz; and
performing Full Wavefield Inversion with the geophysical data set to generate a velocity model.

8. The geophysical data product of claim 1, wherein the process further comprises:
producing an image of the subterranean formation;
recording the image on a non-transitory, tangible computer-readable medium;
bringing the computer-readable medium onshore; and
performing geophysical analysis onshore on the image.

9. The geophysical data product of claim 1, wherein:
the standard-offset survey spread comprises seismic receivers, and
the long-offset streamer comprises low-frequency seismic receivers.

10. The geophysical data product of claim 1, wherein:
the long-offset streamer is at least 12 km in length, and
the standard-offset survey spread comprises a plurality of standard streamers, each of the standard streamers being no more than 12 km in length.

11. A method, comprising:
towing a standard-offset survey spread at a standard-offset spread depth;
acquiring standard-offset survey data for a subterranean formation with the standard-offset survey spread;
towing a long-offset streamer with a long-offset vessel at a long-offset streamer depth;
acquiring long-offset survey data for the subterranean formation with the long-offset streamer; and
assembling the long-offset survey data into a set of grouped-long-offset survey data characterized by a plurality of receiver groupings and a group length of greater than 12.5 m.

12. The method of claim 11, wherein:
the standard-offset spread depth is from 10 m to 30 m, and
the long-offset streamer depth is from 30 m to 200 m.

13. The method of claim 11, wherein the assembling comprises at least one of the following two sub-methods:
(1) for each receiver grouping, summing data from a plurality of receivers in the receiver grouping; and
(2) for each receiver grouping, averaging data from a plurality of receivers in the receiver grouping.

14. The method of claim 11, further comprising, producing a geophysical data set representative of signals having frequencies less than 15 Hz.

15. The method of claim 11, wherein a longest-offset of the long-offset streamer is at least 3 km longer than a longest-offset of the standard-offset survey spread.

16. The method of claim 11, wherein:
the standard-offset survey spread is towed with a standard-offset vessel, and the long-offset streamer is towed along a midline of a path of the standard-offset vessel.

17. The method of claim 11, further comprising:
producing a geophysical data set consisting of frequencies less than 8 Hz; and
performing Full Wavefield Inversion with the geophysical data set to generate a velocity model.

18. The method of claim 11, further comprising:
producing an image of the subterranean formation;
recording the image on a non-transitory, tangible computer-readable medium;
bringing the computer-readable medium onshore; and
performing geophysical analysis onshore on the image.

19. The method of claim 11, wherein:
the standard-offset survey spread comprises seismic receivers, and the long-offset streamer comprises low-frequency seismic receivers.

20. The method of claim 11, wherein:
the long-offset streamer is at least 12 km in length, and
the standard-offset survey spread comprises a plurality of standard streamers, each of the standard streamers being no more than 12 km in length.
